(19) United States
(12) Patent Application Publication
(10) Pub. No.: US 2021/0310781 A1
(43) Pub. Date: Oct. 7, 2021

(54) UNDERWATER CUT AND CAPTURE SYSTEM FOR SUBMERGED MUNITIONS

(71) Applicant: Delta SubSea LLC, Montgomery, TX (US)

(72) Inventor: Scott Paul Dingman, Montgomery, TX (US)

(21) Appl. No.: 17/223,877

(22) Filed: Apr. 6, 2021

Related U.S. Application Data
(60) Provisional application No. 63/005,976, filed on Apr. 6, 2020.

(51) Int. Cl. F42D 5/04; F41B 9/00; B08B 3/02; B08B 9/032; B08B 13/00; B08B 9/023

(52) U.S. Cl. CPC F42D 5/04; F41B 9/0087; B08B 3/024; B08B 2209/032; B08B 13/00; B08B 9/023; B08B 9/0321

(57) ABSTRACT

A system for dismantling submerged munitions is disclosed. The system includes a cleaning tool, a cutting tool, and a washout tool. The cleaning tool is configured to clean a surface of a submerged munition using a high-pressure water jet, and the cutting tool is configured to cut a hole in a submerged munition using a high-pressure abrasive water jet. The washout tool removes contents of the munition using one or more high pressure water jets. The system further includes a frame that houses the cleaning tool, the cutting tool, and the washout tool. The system may be lowered to the ocean floor and includes positioning mechanisms to position the cleaning tool, the cutting tool, and the washout tool relative to the munition to be dismantled. The system is configured to safely capture contents of submerged munitions to prevent release of the contents of the munition into the environment.

### CROSS REFERENCE TO RELATED APPLICATION

This application claims the benefit of Provisional Patent Application No. 63/005,976, filed on Apr. 6, 2020, which is incorporated by reference herein in its entirety.

### BRIEF DESCRIPTION OF THE DRAWINGS

The accompanying drawings are part of this disclosure and are incorporated into the specification. The drawings illustrate example embodiments of the disclosure and, in conjunction with the description and claims, serve to explain various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

FIG. 1. is a three-dimensional view of a submerged munition found on the sea floor.

FIG. 2 is three-dimensional perspective view of a cut and capture apparatus for dismantling submerged munitions, according to an embodiment.

FIG. 3 is side view of a cleaning and cutting assembly, according to an embodiment.

FIG. 4 is a three-dimensional top perspective view of a cleaning and cutting assembly, according to an embodiment.

FIG. 5 is a side view of a cleaning and cutting assembly positioned relative to a munition to be cleaned, according to an embodiment.

FIG. 6 is a side view of the cleaning and cutting assembly of FIG. 5 in operation cleaning a munition, according to an embodiment.

FIG. 7 is a top three-dimensional view of the munition of FIGS. 5 and 6 after a cleaning operation has been performed, according to an embodiment.

FIG. 8 is a side view of a cleaning and cutting assembly positioned relative to a munition to be cut, according to an embodiment.

FIG. 9 is a side view of the cleaning and cutting assembly of FIG. 8 in operation cutting a munition, according to an embodiment.

FIG. 10 is a top three-dimensional view of the cutting tool of FIGS. 8 and 9 in a first configuration, according to an embodiment.

FIG. 11 is a top three-dimensional view of the cutting tool of FIG. 10 in a second configuration, according to an embodiment.

FIG. 12 shows a bottom three-dimensional view of a nozzle of a cutting tool, according to an embodiment.

FIG. 13 shows a first view of a high-pressure abrasive water jet provided by the cutting tool of FIG. 12, according to an embodiment.

FIG. 14 shows a second view of the high-pressure abrasive water jet provided by the cutting tool of FIGS. 12 and 13, according to an embodiment.

FIG. 15 shows a hole cut in a cylindrical steel object by a cutting tool, according to an embodiment.

FIG. 16 shows a side view of a washout tool in a first configuration, according to an embodiment.

FIG. 17 shows a side view of the washout tool of FIG. 16 in a second configuration, according to an embodiment.

### DETAILED DESCRIPTION

This disclosure generally relates to systems and methods for dismantling submerged munitions. Many locations around the world contain submerged unexploded munitions that were discarded during wartime or during military testing operations. While the risk to humans due to accidental explosion may be remote, such discarded munitions pose other risks including environmental contamination. Disclosed systems and methods provide a way to safely dismantle such munitions and to thereby remediate hazards associated with such submerged munitions.

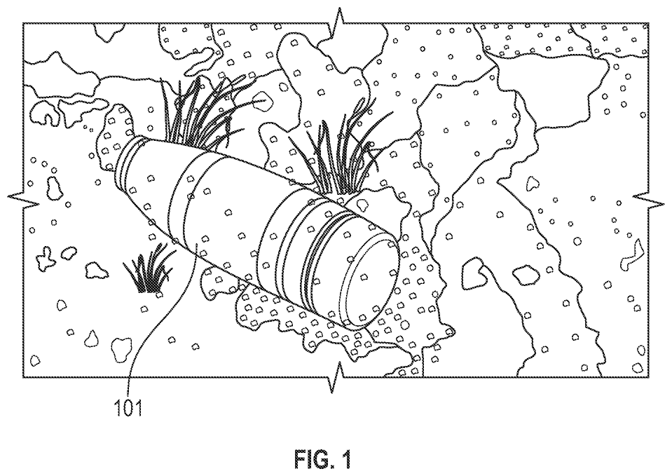

FIG. 1 is a three-dimensional view of a submerged munition 101 found on the sea floor. Removal of the munition 101 for dismantling in a land-based operation poses various hazards including the risk of accidental explosion of munition 101. Therefore, it is advantageous to employ systems and methods that operate to dismantle munition 101 in-situ on the ocean floor, as described herein. Munitions 101 that have been submerged for a long time tend to be covered with various forms of debris. Munition 101, for example, may be bio-encrusted with barnacles, etc. Dismantling of munition 101 therefore includes cleaning a surface region of munition 101, cutting a hole in the cleaned surface of munition 101, and removing the explosives contained therein. A “cut and capture” tool configured to remotely perform these dismantling operations is described in greater detail below.

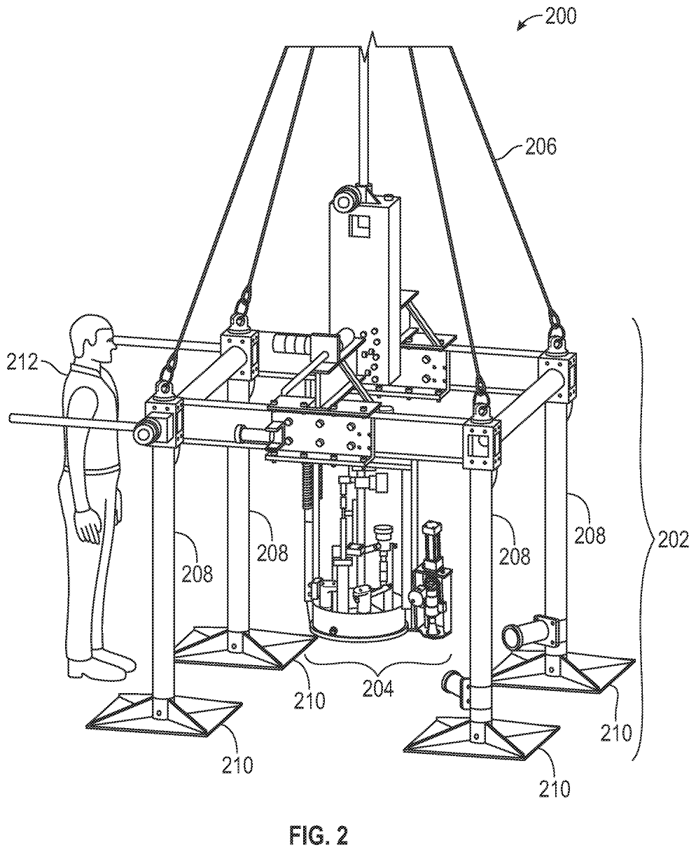

FIG. 2 is three-dimensional perspective view of a cut and capture apparatus 200 for dismantling submerged munitions, according to an embodiment. Apparatus 200 includes a frame structure 202 that houses cleaning and cutting tools in an assembly 204. Apparatus 200 is configured to be lowered to the ocean floor by cables 206. For example, apparatus 200 may be lowered to the ocean floor by a crane that is located on a ship. In alternative embodiments, apparatus 200 may be positioned on the ocean floor by a remotely operated vehicle (ROV) that may position apparatus 200 using a mechanical device (not shown) that may be configured to mechanically connect to apparatus 200 to thereby manipulate apparatus into position on the ocean floor. Frame structure 202 may be provided with support columns 208 that include feet 210. Feet 210 may be configured to support frame structure 202 on the ocean floor. As illustrated, feet 210 may provide a wide flat surface that engages with the ocean floor to thereby reduce a tendency for feet 210 to sink into sedimentary layers of the ocean floor. Apparatus 200 may roughly have a size similar to that of a human 212 in this example. Other embodiments may have various other sizes and shapes as needed for a given application. Frame structure 202 may further include and support a hydraulic system. The hydraulic system may provide various fluidic connections among the various subsystems including a cleaning tool, a cutting tool, and a washout tool, as described in greater detail below. The various fluid connections may also be supported by frame structure 202.

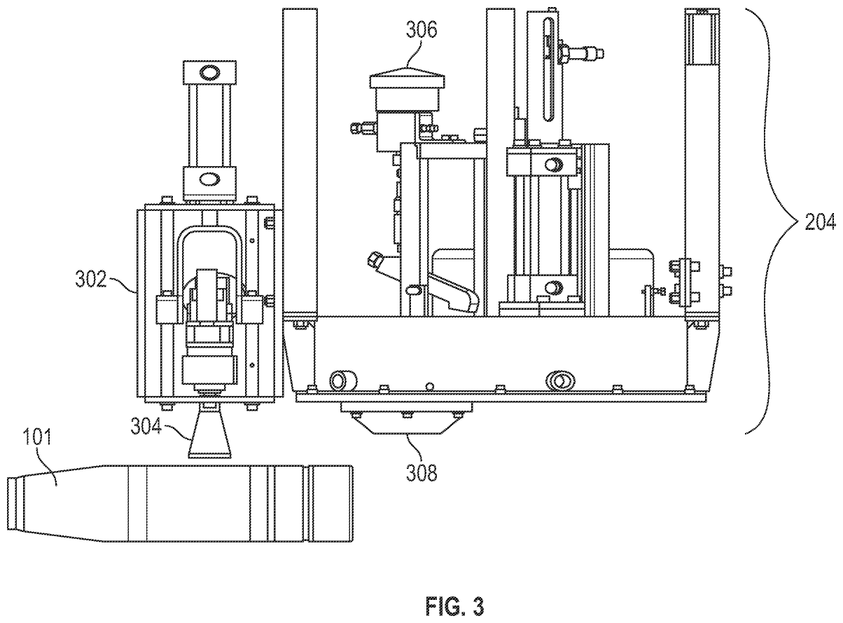

FIG. 3 is side view of cleaning and cutting assembly 204 of FIG. 2, according to an embodiment. In this view, cleaning and cutting assembly 204 is positioned over a submerged munition 101. Assembly 204 includes a cleaning tool 302 which includes a high-pressure water jet apparatus having a nozzle 304. Nozzle 304 is configured to provide a high-pressure water jet that acts to remove debris from munition 101. For example, cleaning tool 302 may provide a water jet having pressure of approximately 60,000 psi. Apparatus 204 further includes a cutting tool 306, having a nozzle 308, which may be configured to provide a high-pressure water jet including abrasive particles. The abrasive water jet provided by cutting tool 306 may have sufficient pressure to cut through a steel casing of munition 101, as described in greater detail below. As mentioned above, cutting tool 306 may provide the abrasive water jet with a pressure of approximately 60,000 psi. Various other pressures may be used by cleaning 302 and cutting 306 tools in other embodiments.

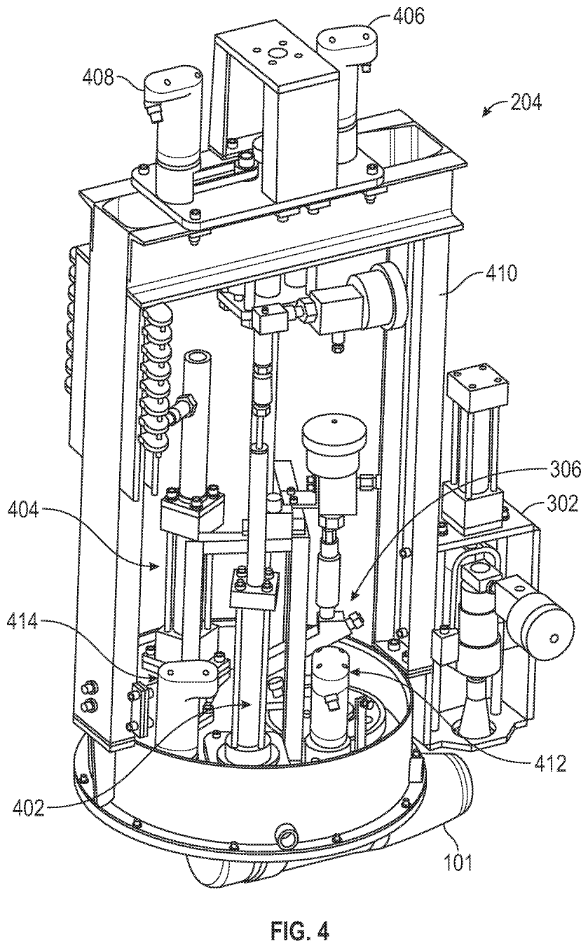

FIG. 4 is a three-dimensional top perspective view of cleaning and cutting assembly 204 of FIGS. 2 and 3, according to an embodiment. As shown, assembly 204 includes cleaning tool 302 and cutting tool 306, described above. Assembly further includes a washout tool 402 that is configured to remove explosives from munition 101. For example, washout tool 402 may be configured to provide one or more water jets at various angles. As described in greater detail below, washout tool 402 may be inserted into a hole in munition 101 that is cut by cutting tool 306. Cutting a hole in munition 101 with cutting tool 306 leaves a plug that must be removed before washout tool 402 may be inserted into the hole cut in munition 101. Therefore, assembly 204 further includes a plug removal tool 404. Plug removal tool 404 may be configured to mechanically attach to a plug cut from munition 101, and once attached, plug removal tool 404 may be configured to remove the plug cut from munition 101. Plug removal tool 404 may include a suction system or other mechanical device that is configured to attach to the plug cut by cutting tool 306.

Assembly 204 may be provided with various positioning devices. For example, a vertical positioning device 406 may be provided. Vertical positioning device 406 may allow assembly 204 to be manipulated vertically into positioned over munition 101. In addition to vertical positioning device 406, a rotational positioning device 408 may be provided. Rotational positioning device 408 may be used to control rotation of assembly 204 during positioning of assembly 204 over munition 101. Vertical positioning device 406 and rotational positioning device 408 may be used to position the various tools of assembly 204 relative to munition 101 to thereby install cleaning and cutting assembly 204 on munition 101. Frame 204 may include further positioning devices. For example, a cutting tool positioning device 412 may be used to move cutting tool 306 relative to munition 101. For example, while holding frame 410 fixed relative to munition 101, cutting tool 306 may be moved in a circle during the cutting operation to thereby cut a circular hole in a shell of munition 101. Similarly, a washout tool positioning device 414 may be provided. Washout tool positioning device 414 may be used to vertically position washout tool 402 relative to munition 101, as described in greater detail below.

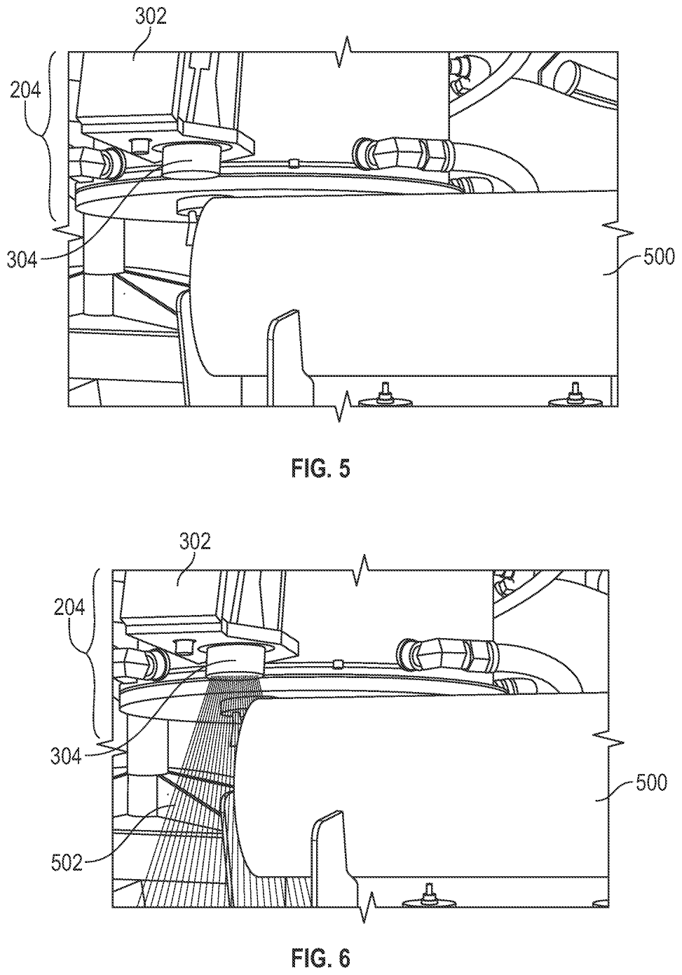

FIGS. 5 and 6 show cleaning and cutting assembly 204 in operation cleaning a munition 500, according to an embodiment. Munition 500 is a cylindrical steel pipe surrounded by a layer of concrete. A portion of cleaning tool 302 is shown on the left-hand side of each of FIGS. 5 and 6. Cleaning tool 302 includes nozzle 304, as described above. Nozzle 304 is configured to supply a water jet at high pressure. For example, nozzle 304 may provide a water jet at approximately 60,000 psi. Other pressures may be provided in further embodiments. FIG. 5 illustrates nozzle 304 in a closed configuration in which there is no water jet. FIG. 6 shows nozzle 304 in an open configuration in which nozzle 304 is delivering a high-pressure water jet 502. In this example, water jet 502 provided by nozzle 304 of cleaning tool 302 has sufficient pressure to remove the concrete coating from munition 500. Cleaning tool 302 is further configured to move along an axial direction along munition 500. In this example, cleaning tool 302 moves from left to right over munition 500. As cleaning tool 302 moves along munition 500, water jet 502 removes the concrete coating from munition 500, as described in greater detail below with reference to FIG. 7.

FIG. 7 is a top three-dimensional view of munition 500 of FIGS. 5 and 6 after a cleaning operation has been performed, according to an embodiment. As described above, munition 500 is a steel pipe 702 that was initially provided with a cylindrical coating of concrete 704. A portion of concrete 704 coating has been removed to expose a surface region 706 of steel pipe 702. FIGS. 5 to 7 demonstrate successful operation of cleaning tool 302 for removal of a hard coating (i.e., a concrete 704 coating) from munition 500. As such, cleaning tool 302 is well suited for removing other tightly affixed debris, such as barnacles, from munitions 101 (e.g., see FIG. 1) that may be found in undersea environments.

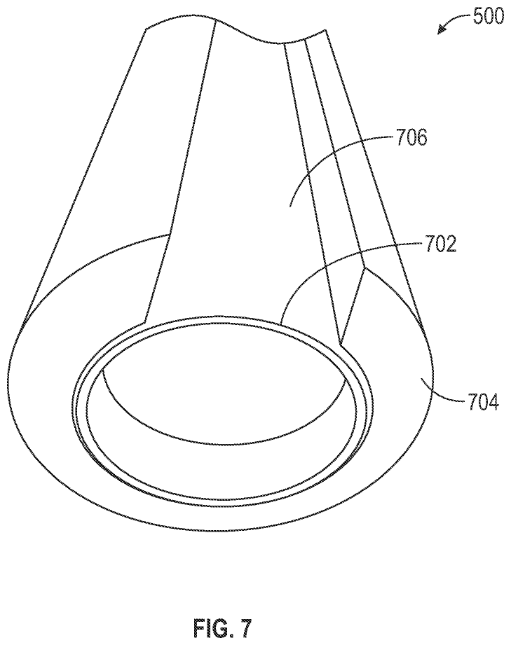

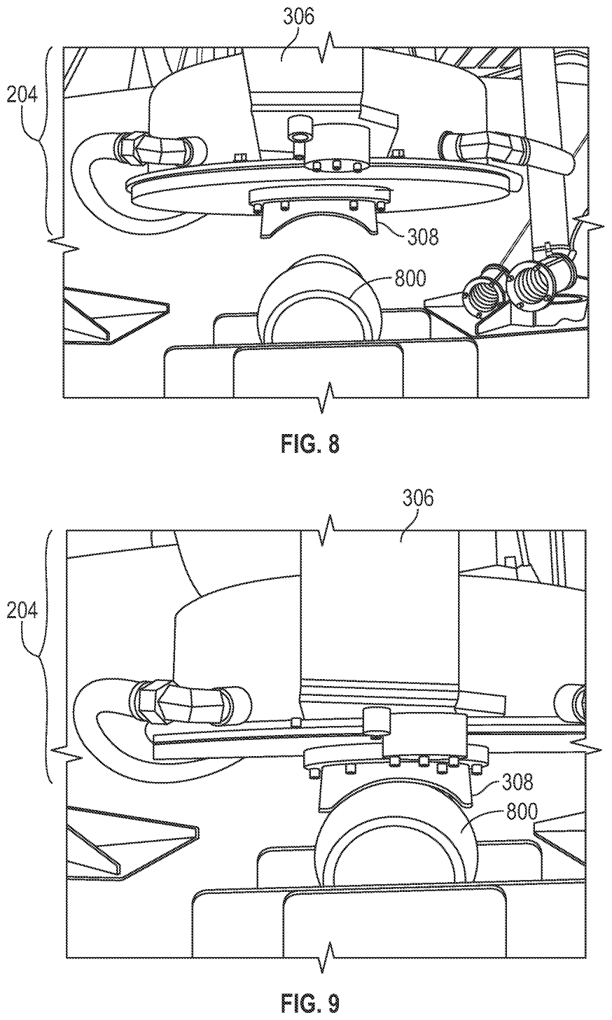

FIGS. 8 and 9 show cleaning and cutting assembly 204 in operation cutting a munition 800, according to an embodiment. FIG. 8 shows cleaning and cutting assembly 204 positioned above munition 800 in a process of installing cleaning and cutting assembly 204 on munition 800. As shown, cutting tool 306 (e.g., see FIGS. 3 and 4) includes a nozzle 308 having a curved surface. The curved surface of nozzle 308 is configured to make close contact with munition 800. In this example, munition 800 is a steel cylinder that has a similar geometry to munitions 101 (e.g., see FIG. 1) that require cutting. FIG. 9 shows cleaning and cutting assembly 204 installed on munition 308. In this regard, cleaning and cutting assembly 204 has been lowered onto munition 800 such that that curved surface of nozzle 308 makes close contact with munition 800. Cutting of munition 800 is performed by supplying a high-pressure abrasive water jet to munition 800. As described and illustrated in greater detail below, cutting tool 306 (e.g., see FIGS. 3, 4, and 10 to 14) may be configured to be moved relative to munition 800. For example, cutting tool 306 may be moved in a circle while supplying the high-pressure abrasive water jet to munition 800. In this way, a circular hole may be cut in munition 800 by the action of the high-pressure abrasive water jet.

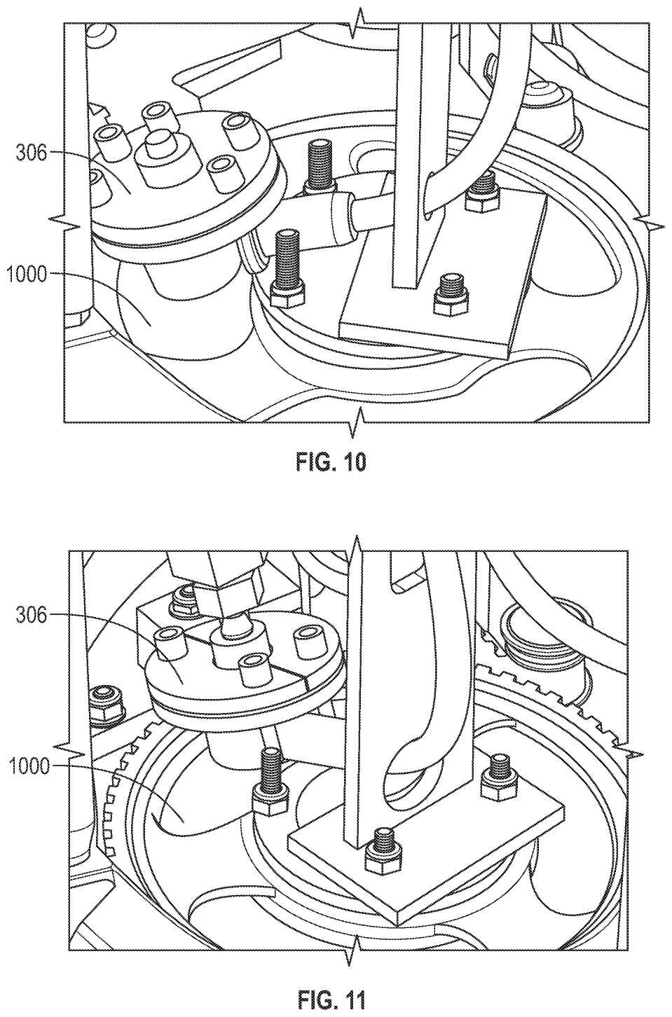

FIGS. 10 and 11 show top three dimensional views of cutting tool 306 in two different configurations during a cutting operation, according to an embodiment. With frame 410 (e.g., see FIG. 4) of assembly 204 held stationary relative to munition 800 (e.g., see FIG. 9), cutting tool 306 may be moved relative to frame 410. In this way, cutting tool 306 may be moved relative to munition 800 during the cutting operation. In this example, cutting tool 306 is mounted to a circular support structure 1000 that is configured to rotate about an axis. In this example, the rotation axis is oriented in an up-down direction in both FIGS. 10 and 11. FIG. 10 shows cutting tool 306 in a first configuration, and FIG. 11 shows cutting tool in a second configuration in which the position of cutting tool 306 has been rotated in a clockwise direction relative to the first configuration of FIG. 10. In this way, cutting tool 306 may be rotated in a complete circle and may thereby deliver the high-pressure abrasive water jet (e.g., jet 1302 of FIG. 13) to a circular region of munition 800. A circular hole (e.g., see hole 1500 in FIG. 15 and related description below) may thereby be cut in munition 800 leaving a circular plug (not shown). The circular plug may then be removed using plug removal tool 404 (e.g., see FIG. 4) described above. The resulting hole 1500 in munition 800 is described in greater detail below with reference to FIG. 15.

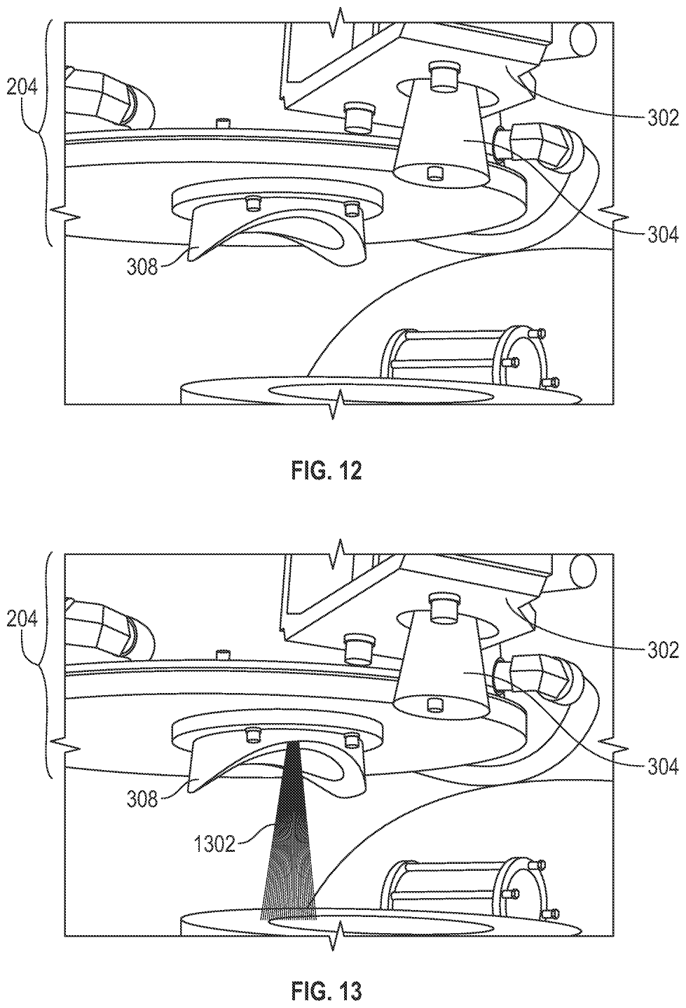

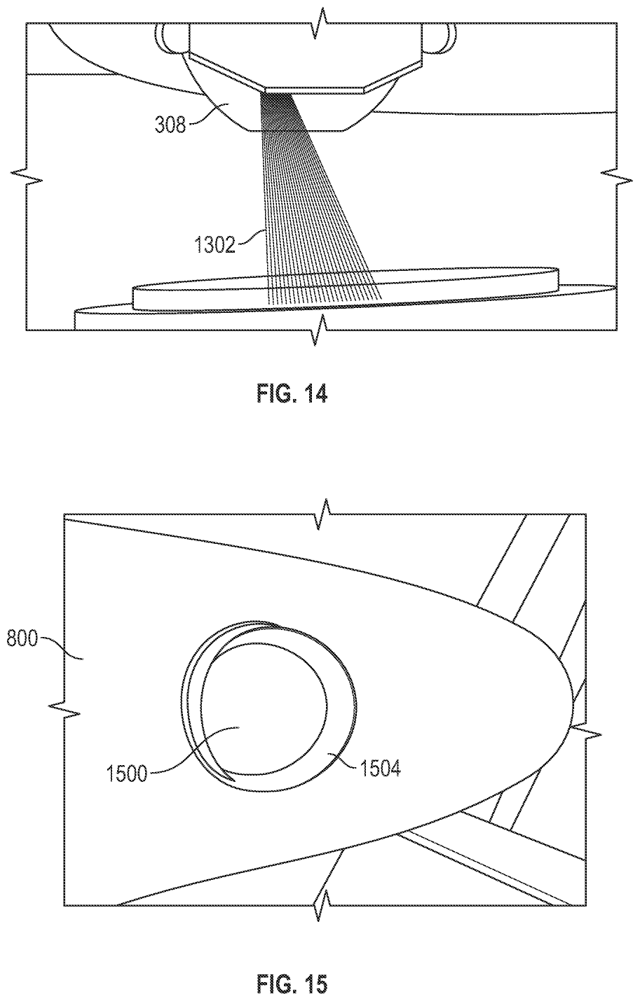

FIGS. 12 to 14 show further details of cutting tool 306 (e.g., see FIGS. 3, 4, 10, and 11) that provides a high-pressure abrasive water jet, according to an embodiment. FIG. 12 shows a bottom three-dimensional view of cleaning and cutting assembly 204. In this view, cleaning tool 302 and cleaning nozzle 304 are shown. In this view, nozzle 308 of cutting tool 306 (e.g., see FIGS. 3, 4, 10, and 11) is also visible. As described above, nozzle 308 includes a curved surface that is configured to make close contact with a surface of a munition (e.g., munition 101 of FIG. 1 or munition 800 of FIGS. 8 and 9). FIG. 13 shows a first view of a high-pressure abrasive water jet 1302. As described above, water jet 1302 may be provided at pressures of approximately 60,000, which is sufficient to cut steel walls of munition 800 or of munition 101. FIG. 13 shows water jet 1302 in a first configuration corresponding to a first configuration of cutting tool 306. FIG. 14 shows water jet 1302 in a second configuration corresponding to a second configuration of cutting tool 306. As can be seen in FIG. 14, water jet 1302 is provided at an angle relative to a vertical axis. The angle of water jet 1302 acts to cut an object (e.g., munition 800) such that the resulting cut surface has an angle 1504, as described in greater detail below with reference to FIG. 15.

FIG. 15 shows a hole 1500 cut in munition 800 by cutting tool 306 (e.g., see FIGS. 3, 4, and 10 to 14), according to an embodiment. As described above, cutting tool 306 may provide a high-pressure abrasive water jet 1302 at an angle, as shown in FIG. 14. The angle of water jet 1302 imposes an angle to the cut surface 1504 of hole 1500. The resulting plug (not shown) that is cut from hole 1500 may be more easily removed from hole 1500 than if the cut surface 1504 was not angled. In this regard, the angle of cut surface 1504 may help to prevent the plug (not shown) that is cut from hole 1500 from falling into munition 800.

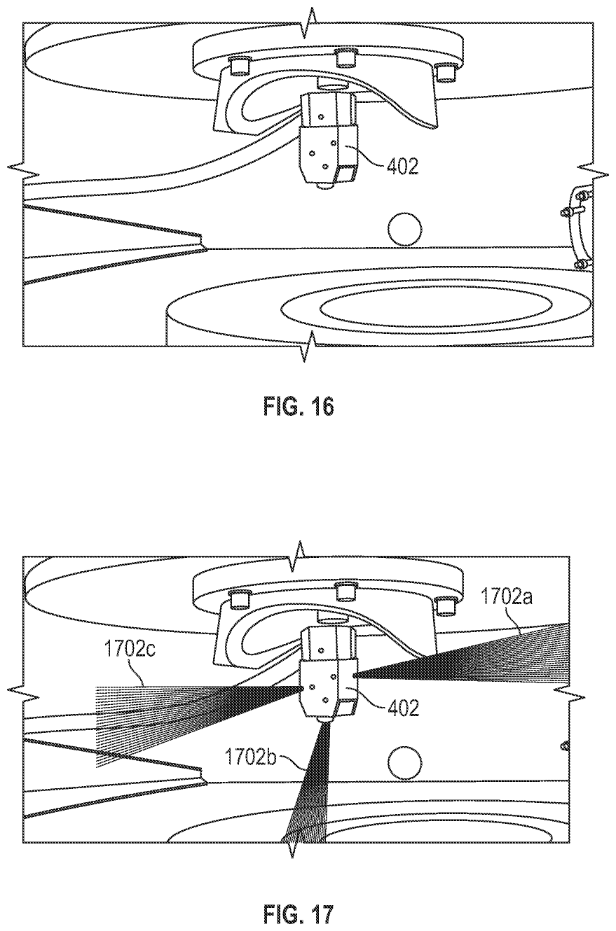

Once a hole is cut and a plug is removed from an actual munition (e.g., munition 101 of FIG. 1), the contents may then be removed. Disclosed embodiment systems provide a washout tool 402, as described above with reference to FIG. 4, that may be used to remove the contents of munitions, as described in greater detail below with reference to FIGS. 16 and 17.

FIGS. 16 and 17 show a side view of a washout tool 402 in first and second configurations, according to an embodiment. As described above with reference to FIG. 4, washout tool 402 may be positioned using a washout tool positioning device 414. Washout tool 402 provides high pressure water jets at various angles that act to remove contents of munitions. When in operation, washout tool 402 may be lowered into the hole 1500 (e.g., see FIG. 15) that has been cut in a munition (e.g., munition 101 of FIG. 1). Washout tool 402 is lowered into hole 1500 while nozzle 308 maintains contact with the munition (e.g., see FIGS. 8, and 9). FIG. 16 shows washout tool 402 in a first configuration in which water jet apertures are closed to prevent flow of the water jets. FIG. 17 shows washout tool 402 in a second configuration in which water jet apertures are opened. In this example, washout tool 402 provides water jets 1702a, 1702b, 1702c in at least three directions. In further embodiments, washout tool 402 may provide water jets in greater or fewer directions as needed for a given application. The action of water jets 1702a, 1702b, 1702c causes the contents of a munition to be dislodged so that such contents may be safely removed and contained by cleaning and cutting tool assembly 204.

Conditional language, such as, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The specification and annexed drawings disclose various example embodiments. The examples illustrate various features of the disclosure, but those of ordinary skill in the art may recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not limiting. Although specific terms are employed herein, they are used in a generic and descriptive sense only, and not used for purposes of limitation.

What is claimed is:

1. A system configured to dismantle a submerged munition, the system comprising:
a frame;
a hydraulic system supported by the frame;
a hydraulic cleaning tool connected to the hydraulic system and supported by the frame, the cleaning tool configured to clean a surface of the submerged munition using a first high-pressure water jet using water supplied by the hydraulic system;
a hydraulic cutting tool connected to the hydraulic system and supported by the frame, the cutting tool configured to cut a hole in the submerged munition using a second high-pressure water jet using water supplied by the hydraulic system, wherein the second high-pressure water jet is an abrasive water jet including abrasive particles supplied by the cutting tool; and
a hydraulic washout tool connected to the hydraulic system and supported by the frame, the washout tool configured to remove contents of a munition using a third high pressure water jet using water supplied by the hydraulic system.

2. The system of claim 1, wherein the frame further supports hydraulic fluidic connections between the hydraulic system and the cleaning tool, the cutting tool, and the washout tool.

3. The system of claim 1, wherein the frame is configured to be lowered to the ocean floor and to be positioned over a submerged munition that is to be dismantled.

4. The system of claim 2, wherein the frame includes positioning devices configured to position the cleaning tool, the cutting tool, and the washout tool relative to a munition to be dismantled.

5. The system of claim 1, wherein at least one of the cleaning tool and the cutting tool provide water jets having a pressure of approximately 60,000 psi.

6. The system of claim 1, wherein the cleaning tool is configured to move along an axial direction along a munition to be dismantled.

7. The system of claim 1, wherein the cutting tool is configured to provide the high-pressure abrasive water jet along a closed path along a surface of the munition to thereby cut a hole in the munition.

8. The system of claim 7, wherein the closed path is a circle such that a circular hole is cut in the munition.

9. The system of claim 7, wherein the cutting tool provides the high-pressure abrasive water jet at an angle relative to a surface of the munition such that a hole is cut in the munition with the hole having an angled cut surface.

10. The system of claim 1, further comprising a curved sealing surface that forms a watertight seal between the system and a curved surface of the munition,
wherein the cleaning tool and the washout tool are configured to provide high pressure water jets to the munition though an aperture of the system that is surrounded by the curved sealing surface.

11. The system of claim 7, further comprising a washout tool positioning device that is configured to move the washout tool into the hole cut by the cutting tool,
wherein the washout tool is configured to supply one or more high pressure water jets to thereby remove contents of the munition, and
wherein the system is configured to retrieve the contents of the munition.

12. The system of claim 7, further comprising a plug removal tool that is configured to remove a plug that is cut from the munition by the cutting tool.

13. A method for dismantling submerged munitions, the method comprising:
providing a high-pressure water jet to a surface of a submerged munition to thereby clean a surface of the submerged munition;
providing a high-pressure abrasive water jet to a cleaned surface of the munition to thereby cut a hole in the munition; and
providing a high-pressure water jet to contents of the munition to thereby remove the contents of the munition.

14. The method of claim 13, further comprising:
using a cleaning tool to clean the surface of the munition;
using a cutting tool to cut the hole in the munition; and
using a washout tool to remove the contents of the munition,
wherein the cleaning tool, the cutting tool, and the washout tool are housed in a frame structure that is configured to be lowered to an undersea location of the munition to be dismantled.

15. The method of claim 14, further comprising:
using positioning devices to position the cleaning tool, the cutting tool, and the washout tool relative to a munition to be dismantled.

16. The method of claim 14, wherein at least one of the cleaning tool and the cutting tool provide water jets having a pressure of approximately 60,000 psi.

17. The method of claim 14, further comprising moving the cleaning tool along an axial direction along a munition to be dismantled.

18. The method of claim 13, further comprising providing the high-pressure abrasive water jet at an angle relative to a surface of the munition such that the hole is cut in the munition having an angled cut surface.

19. The method of claim 14, further comprising using a plug removal tool to remove a plug that is cut from the munition.

20. A method for dismantling submerged munitions, the method comprising:
deploying a system to a submerged location having a submerged munition, the system including a cleaning tool, a cutting tool, and a washout tool;
positioning the cleaning tool, the cutting tool, and the washout tool relative to the munition to be dismantled;
using the cleaning tool to clean a surface of the munition;
using the cutting tool to cut a hole in the munition;
using the washout tool to remove contents of the munition; and
capturing the removed contents of the munition by the system to thereby prevent release of the contents of the munition into a marine environment of the munition.
